(19) United States
(12) Patent Application Publication
(10) Pub. No.: US 2012/0267325 A1
(43) Pub. Date: Oct. 25, 2012

(54) WASTEWATER TREATMENT PLANT AND METHOD FOR TREATING WASTEWATER, AND WASTEWATER TREATMENT SYSTEM

(76) Inventors: Tariq Kaddoura, Berlin (DE); Gert Köhler, Neuruppin (DE)

(21) Appl. No.: 13/386,407

(22) PCT Filed: Jul. 23, 2010
(86) PCT No.: PCT/EP10/60749

§ 371 Date: Jan. 20, 2012

(30) Foreign Application Priority Data
Jul. 23, 2009 (DE) 102009027980.6

(51) Int. Cl. B01D 29/58; C02F 1/00; B01D 29/66

(52) U.S. Cl. 210/805; 210/335; 210/151; 210/333.01; 210/806; 210/257.1; 210/253

(57) ABSTRACT

The invention relates to a wastewater treatment plant and method for treating wastewater, and to a wastewater treatment system having a plurality of filter layers disposed one under the other for purifying the wastewater, wherein at least one feeding device (200) for feeding wastewater to the filter layer (110) and at least one discharge device (300) for discharging the purified wastewater from the filter layer (110) is associated with each filter layer (110). The feeding device (200) for at least two of the filter layers (110) is directly fluidically connected to a wastewater feeding line (400) and the discharge device (300) is directly fluidically connected to an intermediate store (600), such that the unfiltered quantity of wastewater fed to each filter layer (110) can be filtered by said filter layer (110).

The present invention relates to a wastewater treatment plant, in particular a plant for purifying wastewater, a method for treating the wastewater and a wastewater treatment system comprising a plurality of wastewater treatment plants in accordance with the invention.

In order reduce the impact on the environment and to protect groundwater and where it is intended to reuse wastewater and to save money, it is necessary to purify contaminated water. This type of purification can be achieved by means of mechanical and biological treatment of the wastewater. For this purpose, sewage treatment plants are known which at a central location effect purification of wastewater from a large number of households or consumers. Local plants are also known which permit provision of a wastewater treatment plant for individual or a plurality of interconnected households. The small construction size thereof permits only a small flow rate volume of wastewater per unit of time, however by reason of their size and their relatively uncomplicated structure they can be provided set up cost-effectively. The present invention relates in particular to such wastewater treatment plants which are to be set up locally. Such waste water treatment plants can be formed as so-called planted or unplanted soil filters which, for biological purification, utilise layers of sand, gravel or a mixture thereof and optionally comprise a covering of vegetation.

The surface of planted and unplanted filters, through which the wastewater must penetrate for purification purposes, is dependent upon the desired wastewater volume, which is to be purified, per unit of time. Compared with so-called technical plants (e.g. SBR-methods, fixed bed systems, membrane systems) planted and unplanted soil filter systems take up a relatively large amount of surface area. In order to solve this problem, subterranean, substantially shaft-like wastewater treatment plants are known, in which the purification of wastewater is performed with an increased amount of device-related outlay.

Specific approaches for the creation of local wastewater treatment plants are known e.g. from DD 300 015 A7, in which a reed bed is proposed which achieves improved ventilation through different filter layers. The wastewater to be purified flows consecutively through these filter layers.

EP 0 738 687 A1 likewise discloses a sewage treatment plant which comprises individual filter elements, through which water to be purified flows vertically in succession.

A similar plant is taught by DE 100 10 109 A1 which discloses modular filter systems, wherein the wastewater can flow through the individual filter modules for purification.

However, the problem with these wastewater treatment plants is that in order to purify a specific quantity of wastewater, the wastewater must initially pass through a plurality of filter layers before it can be made available again. Therefore, a relatively long treatment time is required for each quantity of water. The entire wastewater treatment plant has to be dimensioned to be correspondingly large in the event that there is an increased requirement for purification. The larger dimensioning of a wastewater treatment plant brings about, in turn, a larger area or volume to be made available and higher production costs.

Therefore, it is the object of the present invention to provide a wastewater treatment plant and a method for treating wastewater and a wastewater treatment system, by means of which, in a convenient and cost-effective manner and with a structurally simple and flexible construction, a wastewater treatment purification can be achieved rapidly and reliably by the utilisation of biological and/or biochemical processes.

In accordance with the invention, this object is achieved by the wastewater treatment plant stated in claim 1. In accordance with the invention, the object is also achieved by the method for treating water stated in claim 12 and by the wastewater treatment system stated in claim 15. Advantageous embodiments of the wastewater treatment plant are described in subordinate claims 2 to 11 and advantageous embodiments of the method for treating wastewater are described in subordinate claims 13 and 14. An advantageous embodiment of the wastewater treatment system is described in claim 16. To supplement the invention, there is also provided a method in accordance with the invention for treating wastewater, in particular for purifying wastewater and utilising the inventive wastewater treatment system in accordance with claim 17.

In accordance with the invention, the object is provided by a wastewater treatment plant having a plurality of filter layers disposed one under the other for purifying the wastewater, wherein in each case at least one feeding device for feeding wastewater to the filter layer and at least one discharge device for discharging the water purified by the respective filter layer is associated with each filter layer. In the case of at least two of the filter layers, the feeding device is directly fluidically connected to a wastewater feeding line and the discharge device is directly fluidically connected to an intermediate store such that the unfiltered quantity of water fed to the respective filter layer is purified exclusively by this filter layer, wherein the wastewater treatment plant comprises a central shaft for discharging the purified wastewater into an intermediate store by utilising gravitational force.

In other words, the wastewater fed to a respective feeding device comes directly from a wastewater line or a wastewater reservoir and not from a preceding, filter layer located above. Equally, the water filtered in this filter layer is not fed to a further, underlying filter layer, but rather is fed directly to an intermediate store, wherein the intermediate store can be a collecting tank, in which the filtered wastewater is collected and then discharged or transported away. Direct connection of the feeding device to the wastewater feeding line or of the discharge device to the intermediate store is to be understood to mean that, without the interconnection of a further filter layer, these components or structural units are fluidically connected to each other. However, the interconnection of conventional hydraulic units, such as e.g. valves or pumps, is not precluded. An essential feature of the invention thus resides in the fact that the feeding to the respective filter layer and the purification and discharge from the filter layer into an intermediate store are accomplished without the interconnection of a further filter layer. In accordance with the invention, at least two of the filter layers and advantageously more than two of the filter layers are each equipped with the direct connections to the wastewater feeding line and the intermediate store, wherein it should not be ruled out that further filter layers disposed in the wastewater treatment plant are connected fluidically to each other such that the water which is already filtered by a filter layer is then fed to a further, underlying filter layer. This means that wastewater can optionally be fed in every second level or filter layer. In this embodiment, the filter layer comprises a perforated base plate, through which the water already filtered by the overlying filter layer can be dripped onto the filter layer disposed below it. Alternatively, it is also possible to provide a separate feeding module.

However, a feeding action is preferably to be provided at each level of the plant. Accordingly, base plates, on which the respective filter layer or filter substrate is applied, are formed in accordance with the invention to be fundamentally impermeable, which means that none of the water filtered by the respective filter layer can pass through the base plate onto the filter layer located below. The filter layer should be formed from a suitable substrate, such as e.g. sand, gravel or a mixture thereof.

The wastewater treatment plant comprises a central shaft which can also be defined as a central column, for discharging the wastewater purified in a respective filter layer into an intermediate store by utilising gravitational force. This central column can likewise be used for receiving a rising pipe, by means of which the filtered wastewater can be discharged from the wastewater treatment plant. Connected to the rising pipe is a pump which is disposed either in the collecting tank at the lower end of the central column or the central shaft or is in fluidic contact with the wastewater treatment plant outside same. Alternatively, the water discharged through the central column could be discharged under the effect of gravitational force where a gradient is present. The central column can be manufactured from a pipe or, in the case of a modular construction of the plant, also from individual pipe sections which, during assembly of the modules, are connected to form a complete shaft. The central shaft is located substantially in the centre of each filter layer or each module so that filtered water can flow radially from all sides into the shaft and thus into the intermediate store. An eccentric arrangement of the central column or of the central shaft is not precluded.

The advantage of the wastewater treatment plant in accordance with the invention resides in particular in the fact that it can be disposed in a space-saving manner, since all of the filter layers are disposed one over or under the other and the wastewater treatment plant can thus be lowered into the ground and does not take up any space above the ground surface. Alternatively, the wastewater treatment plant can also be arranged in the form of a tower having a small footprint.

The assembly outlay for constructing the wastewater treatment plant is relatively low. The advantage over plants in which the wastewater passes consecutively through a plurality of filter layers disposed one over the other, resides in particular in the greater flow rate of wastewater per unit of time, since wastewater is filtered in parallel in a plurality of filter layers and the filtered wastewater can be made immediately available after purification.

In an advantageous manner, a filter layer together with the feeding device and discharge device associated with it forms the essential components of a filter module, wherein the feeding device is disposed over the filter layer and this in turn is disposed over the discharge device. In the wastewater treatment plant, a plurality of these modules are disposed one under the other. By reason of the fact that these modules are disposed one under the other, the wastewater passes, by means of gravitational force or in an enhanced manner by means of a pump, from the respective feeding device into a filter layer from which, in turn, it passes into the discharge device. This procedure is performed substantially simultaneously in each module. In accordance with the invention, in the case of at least two of the filter modules, it is not possible to purify waste water, which is already purified in a filter module, in a further, underlying filter module. The modular construction renders it possible to produce and assemble the wastewater treatment plant in a simple and cost-effective manner and it can be adapted without more significant outlay to suit the respective wastewater treatment requirement. The feeding device does not have to be provided as an extra component, but can be connected to the filter module in the factory, optimally even in a cast component. In an advantageous manner, the discharge device utilises only the gravitational force of the water to transport it away to the intermediate store, e.g. via obliquely extending outlets which terminate above the intermediate store in the central column or in the intermediate store. Therefore, in the wastewater treatment plant in accordance with the invention various functions, such as e.g. feeding, discharge and ventilation, are integrated in one simple-to-handle component, namely the filter module.

In one particular embodiment, vegetation can be disposed in the uppermost layer of the wastewater treatment plant. This uppermost layer thus forms in part a reed bed or vegetation filter system. All of the filter layers or modules disposed below it are pure soil filters, since it cannot be guaranteed that sunlight as required for vegetation growth will fall on these filter layers.

With regard to the constructional design, the wastewater treatment plant is formed in an advantageous manner if the filter module comprises an outer wall and an inner wall, wherein the inner wall serves at least to receive the filter layer and the outer wall serves at least to receive the inner wall and to provide a seal with respect to the outside environment. The outer wall and inner wall are connected by means of connecting elements which serve to maintain a desired distance between the outer wall and the inner wall and thus to provide one or a plurality of vertical ventilation channels. The outer walls provide a seal in particular with respect to the ground if the wastewater treatment plant is sunk into the ground. This seal which can be watertight in design is also provided on transition regions between the outer walls of the respective modules. The plant in accordance with the invention is thus sealed and self-supporting can be installed both in the ground and also above the ground or can be set up in internal spaces, such as e.g. garages or cellars.

The constructional design dictates that the wastewater treatment plant has a ventilation system which produces substantially vertical air flows, wherein the vertical air flows are generated on the outer edge of the filter layers. This means that the distance between the inner wall and the outer wall can be adjusted by means of the linear dimension of the connecting elements such that as a result one or a plurality of ventilation shafts are produced which extend vertically in the wastewater treatment plant and thus provide ventilation which connects the individual filter layers or the gas layers located therebetween. The advantage of this embodiment resides in the improved filter effect brought about by the ventilation. Alternatively, the ventilation could also be produced by means of one or a plurality of ventilation and/or exhaust pipes which extend vertically inside or outside the inner walls over the entire height of the plant. Moreover, it is possible for the wastewater treatment plant to be equipped with an extra forced ventilation and/or exhaust facility which is connected to the vertical space produced between the inner wall and outer wall.

Moreover, it can be provided that the plant comprises a ventilation system which produces substantially horizontal air flows, wherein the horizontal air flows can be generated on the upper surfaces of the filter layers. By virtue of the air flow between the inner wall and outer wall and on account of the injection principle, air is drawn in and discharged between the filter layers or between the modules, whereby as a consequence, at openings to the environment, fresh air thus flows into the intermediate spaces so that horizontal air flows are achieved over the filter layers.

In an advantageous manner, the feeding device comprises a plurality of openings which are directed downwardly in the direction of the filter layer disposed therebelow, in order to discharge the wastewater onto this layer in a substantially laminar manner. In this regard, the feeding device resembles a sprinkler system which is disposed above the respective filter layer which is to be supplied with wastewater.

The invention is formed in an advantageous manner if the feeding device is connected to a feeding line which extends in the central shaft.

This means that, in order to achieve improved ease of maintenance without dismantling the individual filter modules, in one preferred embodiment of the wastewater treatment plant the feeding procedure can be effected via the central column or the central shaft. For this purpose, the feeding line is to be routed within the central shaft. For this purpose, at the height of the horizontal air spaces of the individual filter levels, the central shaft is to be provided with openings, through which the water to be purified can be distributed to the substrate surfaces of the individual filter modules by means of suitable distribution devices. Possible distribution devices include e.g. sprinklers or spray nozzles which effect the feeding procedure out of the central column through the openings. Depending upon the exit angle of the distribution devices, a plurality of distribution devices can also branch off from the feeding line at one level, wherein for each distribution device a corresponding opening is to be provided in the central column.

In a further advantageous configuration of this embodiment, it is provided that the feeding line, together with a rising pipe and a pump connected to the rising pipe, forms a compact structural unit.

This compact structural unit can also comprise electrical connections for the pump which serves to convey the processed wastewater out of the processing plant. Furthermore, the compact structural unit can comprise a support system or linkage, by means of which all of the elements which are to be introduced into the central shaft (e.g. within the scope of maintenance work) can be removed all together from the central shaft and can move automatically to the respectively correct position via a suitable guidance system when they are being introduced into the central shaft. This automatic precise positioning is significant in particular for the function of the feeding device which extends in the central shaft, since the waste water must be discharged exactly through the openings in the central shaft or in the central column.

In order to achieve optimum ventilation, provision is made in this embodiment that the wastewater treatment plant comprises a ventilation line system for introducing air into each filter level. For this purpose, one or a plurality of ventilation lines are provided which are disposed alone or in addition to the vertical ventilation device. The lines which are formed as ventilation pipes extend in an advantageous manner within the substrate or along the wall of the filter module and comprise, at all levels in each case above the substrate surfaces, openings for discharge of air into the horizontal air space. In order to prevent an exchange of air between the central shaft and the horizontal air space, the central shaft is to be provided with connection openings, through which the water is discharged by means of distribution devices, such that, when the distribution devices are being positioned, an airtight connection is produced, or the openings are sealed by the distribution devices.

During or immediately after the feeding procedure, the wastewater flowing downwards in the substrate produces a negative pressure on the substrate surface. As a result, air is drawn out of the ventilation lines initially into the horizontal space and then into the substrate. At the same time, the wastewater flowing downwards moves “used” (i.e. oxygen-poor) air located in the substrate through the drainage devices into the central shaft, from where it is finally guided out of the plant. In this way, the ventilation and exhaust processes are substantially separated from each other, whereby an improved supply of oxygen to the microorganisms located in the substrate is achieved.

In a particular embodiment, it can be provided that the wastewater treatment plant comprises at least one additional ventilation and backwashing device. By means of this device, air or clear water can be introduced as required into the filter layer in order to optimise the biological processes (oxygenation) or to flush the substrate. This type of backwashing serves to counteract colmation processes and extends the serviceable life of the plant.

In accordance with the invention, there is also provided a method for treating wastewater, in particular for purifying wastewater, utilising the wastewater treatment plant in accordance with the invention, wherein wastewater is fed to a plurality of filter layers via their respective feeding devices, is filtered by means of the respective filter layer and the filtered wastewater is discharged by means of a discharge device, which is associated with the filter layer, into a central shaft for discharging the purified wastewater into an intermediate store by utilising gravitation force, and is made available to be recirculated for further purification, re-use or disposal. In accordance with the invention, at least some partial quantities of the wastewater is filtered in merely one filter layer in each case, wherein the filter layers filtering the different partial quantities have a respectively different geodetic height. The different partial quantities do not relate to different volumes but rather to different batches or units of the wastewater. In an advantageous manner, the filter layers are disposed one under the other in accordance with the wastewater treatment plant in accordance with the invention. The discharge device conveys the filtered wastewater preferably into an intermediate store, from where it can be pumped away or reused.

The method is supplemented by the feature that the wastewater which is filtered in the wastewater treatment plant is either disposed of or reused or is directed to further purification by being fed once again into the wastewater treatment plant. This type of renewed feed thus effects a recirculation of the wastewater in the wastewater treatment plant.

In a preferred manner, it is provided that the wastewater partial quantities are filtered at least in part at the same time. That means that the purification is performed in a plurality of filter layers at the same time, so that a higher wastewater flow rate per unit of time can be achieved. It is possible that the purification of individual partial quantities of the wastewater is started in staggered fashion with respect to time, wherein, however, purifications in different filter layers have identical time segments. It is also provided that the wastewater is applied to the respective filter layers intermittently by the feeding devices.

The present invention also relates to the feature of a wastewater treatment system which comprises at least one wastewater treatment plant in accordance with the invention and also at least one wastewater reservoir, which is fluidically connected to the wastewater treatment plant, for the purpose of receiving the unpurified wastewater. In an advantageous manner, a plurality of wastewater treatment plants having one or a plurality of reservoirs are combined in one system, wherein the unfiltered wastewater is fed from the respective reservoir to the respective filter layer by means of the feeding device.

Of course, such wastewater treatment systems also comprise lines, valves and pumps. The wastewater reservoir can be the same component which also functions as an external container of the wastewater treatment plant (completed shaft or annular construction). A possible arrangement of the wastewater treatment plant could be located inside the wastewater reservoir itself, if the reservoir is large enough in dimension.

In one particular structural embodiment, the wastewater treatment system can be designed in such a manner that, when a plurality of wastewater treatment plants are connected in parallel, the intermediate stores are fluidically connected to each other and in this way provide a complete intermediate store. It is thus possible to minimise the costs and installation volume for the corresponding intermediate stores.

The invention is supplemented by a method for treating wastewater, in particular for purifying wastewater and utilising the wastewater treatment system in accordance with the invention, wherein in order to recirculate and discharge the purified wastewater two pumps are provided, and, depending upon the purification objective, the pumps are operated in alternating fashion, so that water collected in the complete intermediate store undergoes recirculation once and is then discharged. The recirculation is effected via the normal feeding line which is blocked by means of a non-return valve in the direction of preliminary sedimentation.

The invention will be explained hereinafter with reference to the accompanying drawings, in which

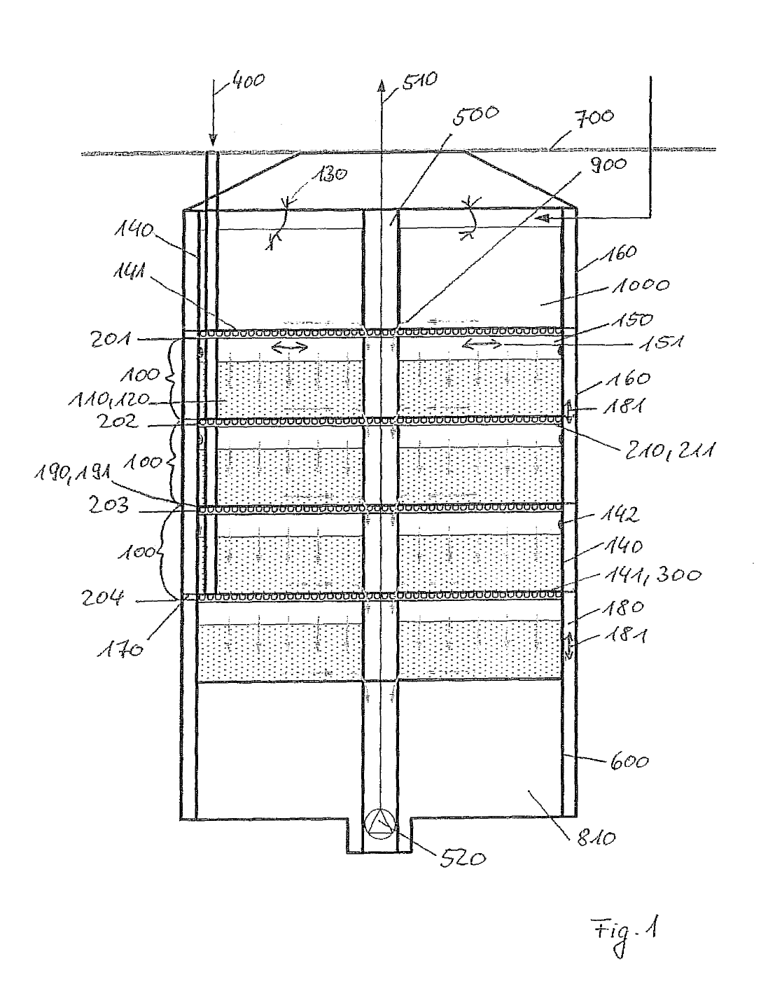

FIG. 1 shows a wastewater treatment plant in a longitudinal sectional view,

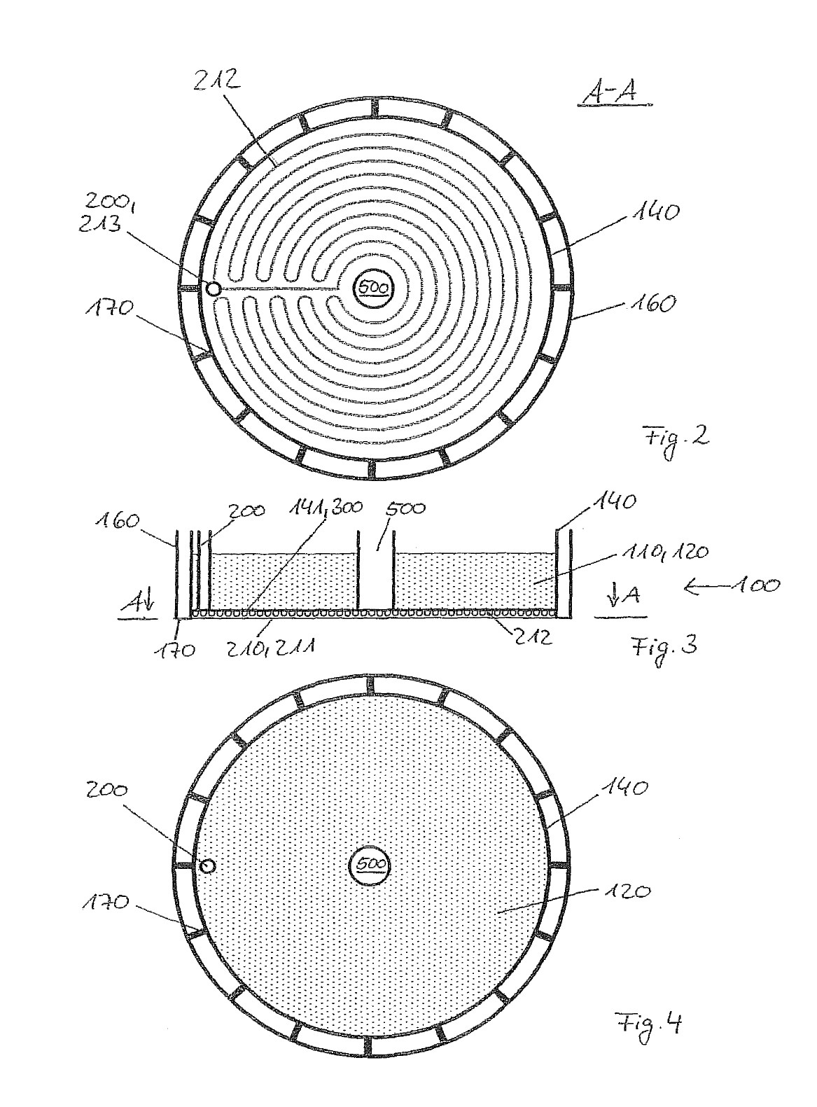

FIG. 2 shows an inner wall and outer wall of a filter module in a view from above,

FIG. 3 shows a filter module in a sectional view from the side,

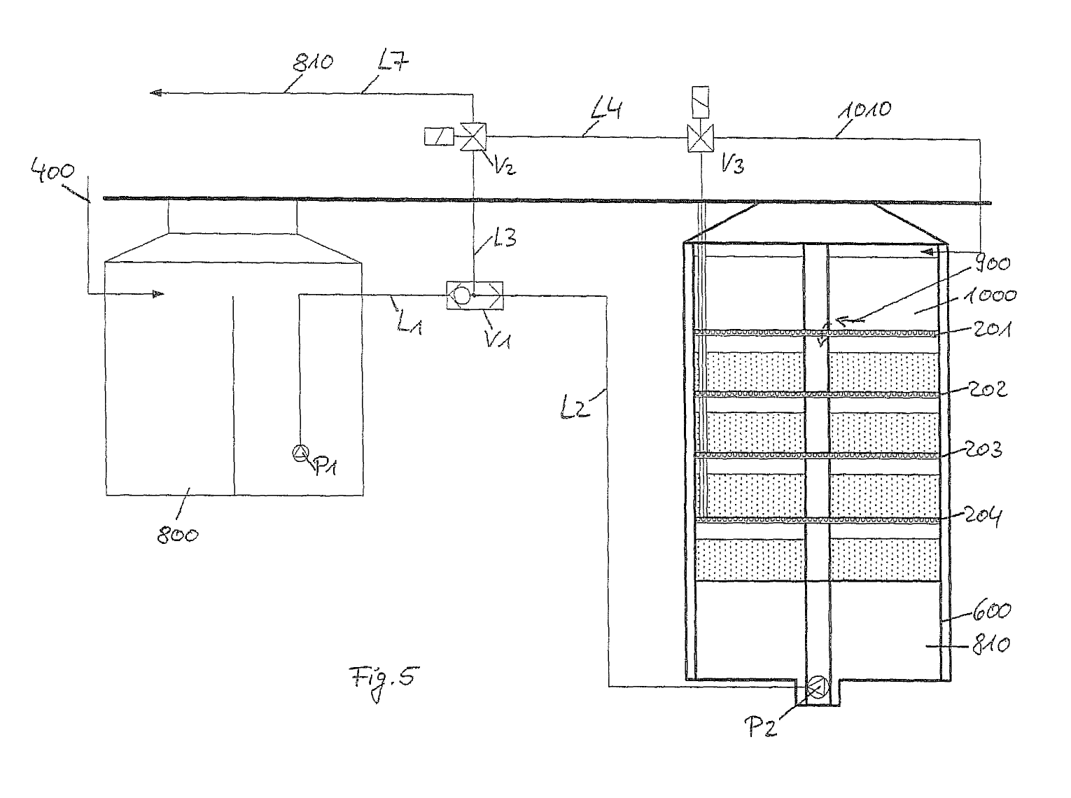

FIG. 4 shows a filter module in a view from above,

FIG. 5 shows a wastewater treatment system having two pumps, and

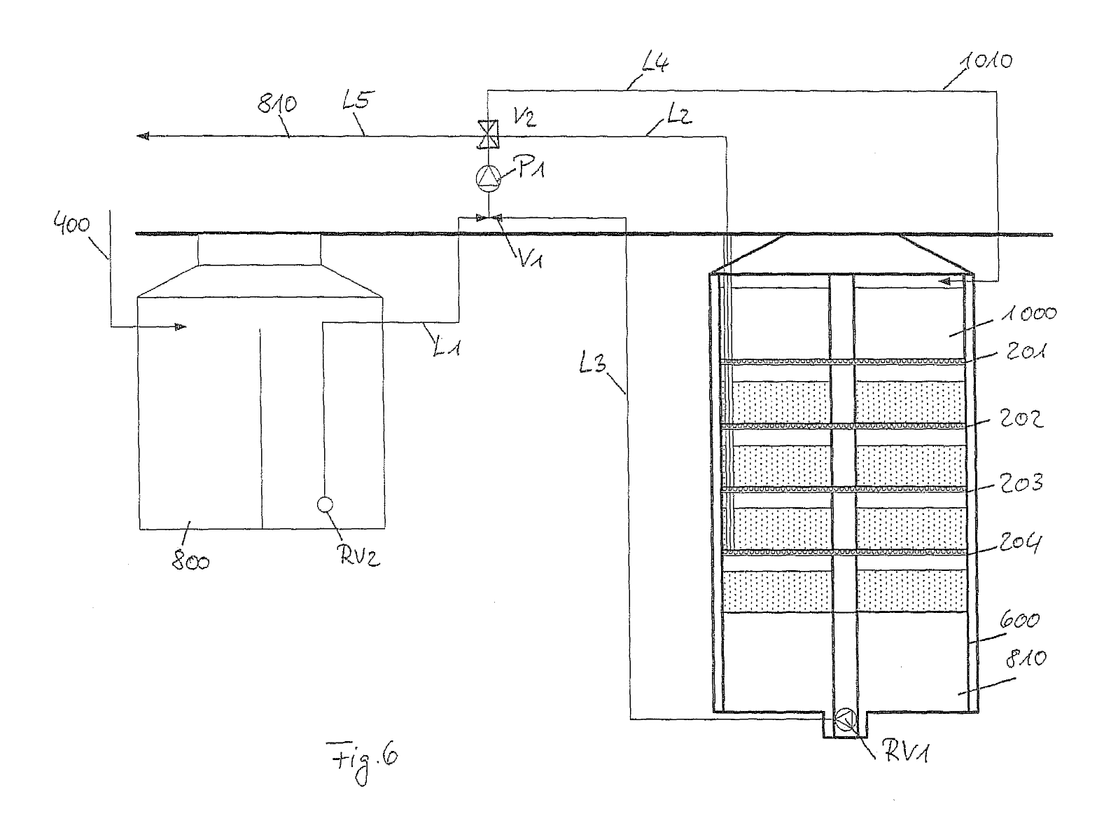

FIG. 6 shows a wastewater treatment system having one pump.

The wastewater treatment plant in accordance with the invention, as illustrated in FIG. 1, is constructed substantially from individual filter modules 100, an intermediate store 600 disposed therebelow, feeding devices 201 to 204 and discharge devices 300. The substantially cylindrical wastewater treatment plant thus produced can be disposed in the ground, so that it is located under the ground surface 700. All of the feeding devices 201 to 204 are connected to a wastewater feeding line 400. Disposed at the bottom of the intermediate store 600 is an underwater submersible pump 520 which transports the filtered water from the wastewater treatment plant by means of a rising pipe 510.

The respective filter modules 100 each comprise an outer wall 160 and an inner wall 140 disposed therein. As illustrated in FIG. 1, the respective feeding devices 201 to 204 and the discharge devices 300 are integral components of the filter modules 100, wherein the invention is not limited to the integration of the feeding devices and discharge devices in the filter modules 100, but rather can also be configured in such a manner that the feeding devices and discharge devices are extra structural units located outside the filter modules 100 and comprising connections to the filter modules.

The respective outer wall 160 provides the filter module with mechanical strength against external effects, e.g. pressure exerted by the ground. It also serves to seal the plant with respect to the ground. If the external container is produced in an annular design, the connecting regions between the rings are likewise connected to each other, so as to prevent any ingress of contaminants.

The inner walls 140 are at least partially filled with suitable substrate layers, such as e.g. sand, gravel, synthetic substrates or mixtures thereof In such a substrate layer, mechanical, chemical and biological processes are performed for purifying or purifying the wastewater. In the uppermost filter module, a filter substrate can be disposed which is suitable for receiving plants 130. That means that the uppermost filter module can be formed as a reed bed, as an alternative to a denitrification stage without a covering of vegetation.

A component of a respective inner wall 140 is a base plate 141 which is fixedly connected to the substantially hollow-cylindrical inner wall. The base plate 141 and the inner wall 140 together thus provide an inner trough. The base plate 141 effects the discharge of the purified wastewater. For this purpose, the base plate 141 preferably has a slight incline which is directed towards a central column provided in the centre of the respective inner wall 140. The base plate 141 configured in this manner thus also constitutes the respective discharge device 300.

The inner wall 140 is connected to the outer wall 160 preferably via connecting elements 170 which maintain a constant distance between the inner wall 140 and the outer wall 160.

In a particular embodiment, for purification purposes and for the purpose of facilitating the replacement of the filter substrate, it is provided that the inner wall 140 and the outer wall 160 are produced as separate components in each case. Accordingly, the outer walls 160 are provided in an annular form, so that, when a plurality of these rings are stacked, a shaft is produced which provides the seal with respect to the ground. Instead of production from individual rings, a completed shaft or container for receiving the inner walls can also be used. In this embodiment, connecting elements 170 can also be disposed between the inner walls 140 and the outer walls 160. In order to facilitate insertion or removal of the inner walls 140 into/out of the outer walls 160, the inner wall can optionally have a suitable guide which can be provided e.g. by slides, rollers or grooves. In the case of an integrated line arrangement for feeding or for discharging wastewater in the filter modules, it is simultaneously possible to produce the line system for feeding and for discharging wastewater by connecting these line sections during stacking of the troughs.

In a preferred embodiment illustrated in FIG. 1, the wastewater running off from a respective base plate 141 of a filter module 100 passes via the central column 500, which is disposed centrally in the filter module, preferably in freefall into the intermediate store 600. The central column 500 is formed as a component of a respective filter module 100. Essentially, it is in the shape of a pipe and is fixedly connected to the respective base plate 141. In an alternative embodiment, the central column could also be supplied as a separate pipe section with a seal and can only be connected to the respective base plate 141 at the time of installation.

Alternatively, the inner walls can be inserted into a completed container or shaft (possibly already provided on site). In this embodiment, the outer walls are replaced by an external container. In this case, the connecting elements do not have any static function but are used merely for guidance or alignment purposes. In the case of an above-ground construction of the plant, the external container can be dispensed with completely since in this case there is no earth pressure and ventilation is already present.

When a plurality of filter modules 100 are stacked, the individual pipe sections are connected to form a continuous central column 500. The central column 500 is used primarily to receive and discharge the drainage water from the filter modules 100 into the intermediate store 600. In order to ensure the discharge of the purified wastewater from the filter modules 100, the central column 500 or segments thereof have openings disposed therein, through which the wastewater, which is filtered in the respective filter module 100, can pass into the central column 500 and thus into the intermediate store 600. The central column 500 also serves as a pump shaft for the underwater submersible pump 520 which is disposed at the lowest point in the intermediate store 600. By means of this underwater submersible pump 520, the filtered wastewater 810 which is received in the intermediate store 600 is pumped out of the wastewater treatment plant via the rising pipe 510 and is made available for renewed usage or to drain away in the environment. In addition, the central column 500 has an important static function and can also receive electrical lines for the purpose of supplying power to the underwater submersible pump 520.

In an alternative embodiment, a pump can be installed in a dry state above the central column 500 and a suction line can be sunk from this pump to the bottom of the intermediate store 600.

The present wastewater treatment plant has the advantage that the filter layers are ventilated vertically as a result of the vertical intermediate space between the outer wall 160 and the inner wall 140 which produces one or a plurality of ventilation channels 180. Disposed in these vertical ventilation channels 180 are the aforementioned connecting elements 170. The vertical ventilation channels 180 provide an air flow or gas flow along the outer edges of the filter layers 110.

Above the filter substrates 120, the inner walls 140 are provided with ventilation holes 142, through which air can pass into the respective horizontal intermediate space 150 between the filter modules 100. This horizontal air flow 151 is of considerable importance for the supply of atmospheric oxygen to the substrate space, since during feeding from this space air is absorbed and drawn in through the filter substrate 120 as the waste water seeps through. In order to further improve the ventilation between the filter modules, the vertical exhaust channel 180 can be provided with an existing additional forced ventilation and exhaust system.

An essential feature of the present invention is the integration of a feeding device 200 into a respective filter module 100, as shown in particular in FIGS. 2 to 4. The integrated feeding device 200 can comprise a feeding plate 210, into the upper side of which a hollow system 212 is integrated. The upper side of the feeding plate 210 comprises openings 211, through which wastewater can be directed onto a filter layer 110 disposed therebelow. The openings 211 are preferably distributed over the feeding plate 210, so that the wastewater can be applied substantially over the surface of the filter substrate 120 located therebelow. The present invention is not limited to the integrated feeding plate 210, on the contrary it can also be provided that above a module 100 there is located an extra feeding device which is not connected to the base plate of the module 100 located thereabove and can likewise effect feeding of the surface of the substrate 120 of the module located therebelow. However, in a preferred embodiment as illustrated in FIG. 3, the feeding device 200 is an integral component of the filter module 100.

The feeding device 200 comprises the hollow system 212 which is configured preferably in the form of a convoluted line, as illustrated in FIG. 2. When a plurality of filter modules 100 are stacked, the respective lines are connected to the feeding device 200 e.g. by means of crimp connections or plug-in connections. For this purpose, the vertical lines can be produced either as integrated pipe sections fixedly connected to the inner wall, or merely pipe connections can be provided, into which suitable pipe sections can then be inserted. The connection points are located within the inner wall 140, whereby groundwater seepage into a watercourse is precluded even when the connection is not completely sealed. In an advantageous manner, the feeding device 200 is connected to the respective filter modules during the production process or is produced directly from a cast therewith. However, alternatively the feeding device 200 can be produced in a further production step and is only connected to the respective filter module 100 by suitable manufacturing methods at the time of installation of the plant.

The connection between the feeding device 200 and the feeding plate 210 is established preferably by means of a T-piece 213 which is connected to the hollow system 212. The T-piece serves to pressurise the hollow system 212 in two directions simultaneously. As a consequence, improved pressure distribution is achieved and suspended matter are also prevented from settling at a closed end of the hollow system.

Provision does not necessarily have to be made exclusively as shown in FIG. 3 that the feeding device 210 is connected to the feeding plate 210 inside the inner wall 140, instead the feeding device 200 can also be connected externally to the feeding plate 210. For this purpose, the outer wall 160 of the filter module 100 is to be provided with a sealed passage opening (not shown) which is formed e.g. when two filter modules 100 are joined together. In contrast to the embodiment of the wastewater treatment plant illustrated in FIG. 1 and the embodiment of a filter module 100 illustrated in FIG. 3, it is possible in the wastewater treatment plant to omit feeding devices 200 between two or a plurality of filter modules. The wastewater is then purified in such a manner that the base plate 141 of a filter module would comprise openings (not shown), through which the wastewater, which is filtered by an upper filter layer 110, would then pass directly into the underlying filter module and the filter substrate 120 thereof. This can be expedient e.g. in the case of heavily contaminated industrial or commercial wastewater, so that it passes through a plurality of filter layers 110. However, the wastewater treatment plant in accordance with the invention is configured in such a manner that at least two of the filter modules 100, which are disposed in the wastewater treatment plant, or the filter layers 110 thereof are equipped with an extra feeding device 200, so that the wastewater fed to these filter layers 110 is filtered exclusively by these filter layers and not by a further, underlying filter layer.

In order to prevent colmation phenomena within the substrate and in order to improve the conditions for the biological processes, water or air can be introduced at high pressure from below, preferably by the respective feeding devices 200, into the respective substrate layers 120. For this purpose, additionally disposed flushing systems (not shown) can also be used alongside the feeding devices 200. For this purpose, the base plate 141 of a respective filter module 100 can be provided with bores which extend as far as into the feeding device 200 mounted therebelow, through which flushing water or compressed air can pass into the filter substrate 120 disposed thereabove.

The fourth, lowermost feeding device 204 does not necessarily have to be configured with the feeding plate 210 and the openings 211, since a filter layer is no longer located underneath it. However, in order to ensure a simple modular construction, it can still be expedient from a financial point of view to configure the fourth feeding device 204 in exactly the same way as the other feeding devices 201 to 203, in order to avoid an additional logistical and manufacturing outlay.

It is thus possible to produce the wastewater treatment plant in accordance with the invention as illustrated in FIG. 1, wherein a plurality of filter modules 100 are stacked one on top of the other. The supply of atmospheric oxygen to microorganisms in the filter substrates 120 is effected via the intermediate spaces between the outer wall and inner wall 160 and 140 in the vertical air flow 181 and via the horizontal intermediate spaces 150 between the feeding devices 201 to 204 and the substrate surfaces. Stacking a plurality of filter modules produces continuous vertical ventilation channels 180. The number of filter modules used depends upon the quantity of wastewater which is to be treated per unit of time by the wastewater treatment plant.

If a plurality of wastewater treatment plants in accordance with the invention are disposed in parallel, a plurality of intermediate stores 600 can be connected to each other. For this purpose, the floors of the intermediate stores 600 are to have predetermined breaking points disposed therein which, where required, can be opened and connected to pipelines, in order thus to discharge the commonly collected water via only one pump.

FIGS. 5 and 6 illustrate wastewater treatment systems which comprise essentially the wastewater treatment plant in accordance with the invention, as illustrated in FIG. 1, and in each case at least one wastewater reservoir 800 which is connected by means of lines to the wastewater treatment plant. The wastewater which is to be purified is moved from the wastewater reservoir 800 via the lines into the wastewater treatment plant or onto its filter substrate 120, through which wastewater is then passed. The falling wastewater generates a negative pressure on the surface of the filter substrate 120, as a result of which air is drawn into the filter layer 110. The microorganisms in the filter layer 110 are supplied with atmospheric oxygen in this manner. The filtered wastewater is directed in the manner described into the intermediate store 600, from where it can be directed to facilities for disposal, re-use or more extensive purification (e.g. in the form of recirculation, denitrification, dephosphating or sanitation). In the case of recirculation, the filtered wastewater is reintroduced into the filter modules. For the purpose of denitrification, the filtered wastewater or even unfiltered wastewater can be fed via the denitrification line 1010 to the denitrification stage 1000 of the wastewater treatment plant, from where is it fed in the flow direction 900 to the intermediate store 600. The denitrification stage, dephosphating stage or sanitation stage are formed as additional modules which are formed either inside the modular system of the wastewater treatment plant or can be disposed outside the plant. The sanitation procedure can be performed e.g. by means of UV-radiation, diaphragm technology, ozonisation or sand or quartz filters, in particular UV-radiation could even take place in the intermediate store.

The wastewater treatment system can be operated with two pumps (as shown in FIG. 5), and also with only one pump (as shown in FIG. 6).

Reference is made in the first instance to the embodiment variant in accordance with FIG. 5.

The intermediate store is nitrified or filled by virtue of the fact that a first pump P1 is conveys the wastewater into the feeding device 201, 202 and 204 in a time-controlled and quantity-controlled manner through the lines L1, L3, L4 and through the valves V1, V2, V3. In an advantageous manner, the first pump P1 has protection against dry running LS1±. Biological purification of the wastewater is effected in such a manner that, when pumps P1 and P2 are switched off, wastewater flows through the filter layers and is then collected in the intermediate store 600. The intermediate store 600 is emptied by the operation of the pump P2 which discharges the filtered wastewater in a time-controlled or quantity-controlled manner through the lines L2, L3 and L7 and the valves V1 and V2 for the purpose of disposal or re-use. The recirculation is effected alternatively for emptying purposes by virtue of the fact that the pump P2 conveys the wastewater into the feeding devices 201, 202, 203 and 204 in a time-controlled or quantity-controlled manner through the lines L2, L3, L4 and through the valves V1, V2, V3. Biological purification can then be conducted as described above.

Denitrification is effected in such a manner that the first pump P1 conveys a small quantity of wastewater out of the wastewater reservoir in a time-controlled or quantity controlled manner through the lines L1, L2, L4 and through the valves V1, V2 and V3. The second pump P2 then conveys water out of the intermediate store to the denitrification stage 1000 in a time-controlled or quantity-controlled manner through the lines L2, L3, L4 and through the valves V1, V2, V3. In order optionally to clean the line L3 and the valve V1 before wastewater is directed out of the line L2 via the valve V1 and V2 into the line L7, a flushing operation can be performed by virtue of the fact that the second pump P2 pumps a small quantity of purified wastewater from the intermediate store 600 to the denitrification stage 1000 via the lines L2, L3, L4 and via the valves V1, V2 and V3. Any wastewater present in the line L3 and in the valve V1 is directed to the denitrification stage 1000.

The operation of the wastewater treatment system in accordance with the invention using only one pump P1 is explained in accordance with FIG. 6. The intermediate store 600 is nitrified or filled by virtue of the fact that the first pump P1 draws in wastewater in a time-controlled or quantity-controlled manner through the line L1 and the valve V1 and conveys it to the feeding devices 201, 202, 203 and 204 via the valve V2 and the line L2. Biological purification is conducted in such a manner that the first pump P1 is switched off and waste water flows through the filter layers and is then collected in the intermediate store 600. The intermediate store 600 is emptied by virtue of the fact that the pump P1 draws in wastewater in a time-controlled or quantity controlled manner through the line L3 and the valve V1 and discharges the wastewater via the valve V2 for the purposes of disposal or re-use.

The recirculation is effected alternatively for emptying purposes by virtue of the fact that the pump P1 draws in wastewater in a time-controlled or quantity-controlled manner through the line L3 and the valve V1 and conveys it to the feeding devices 201, 202, 203 and 204 via the valve V2 and the line L2, and this is followed by biological purification as described above.

Denitrification is effected by virtue of the fact that the pump P1 draws in wastewater in a time-controlled or quantity-controlled manner through the line L1 and the valve V1 and draws a small quantity of wastewater from preliminary sedimentation or the wastewater reservoir via the valve V2 and the line L4. Subsequently, the pump P1 draws wastewater in a time-controlled or quantity-controlled manner through the line L3 and the valve V1 and conveys it to the denitrification stage 1000 via the valve V2 and the line L4.

In order in this embodiment to clean the pump P1 and the valve 2 before water is directed out of the line L3 via the valve V1, the pump P1 and the valve V2, a flushing operation can be conducted beforehand such that the pump P1 conveys a small quantity of purified water from the intermediate store 600 to the denitrification stage 1000 via the lines L3 and L4 and via the valves V1 and V2 and the pump P1. Any wastewater present in the pump P1 and/or in the valve V2 is thus directed to the denitrification stage 1000.

In the denitrification stage 1000, the exclusion of oxygen and the use of a suitable substrate create the conditions required for achieving anaerobic bacterial conversion of the nitrate-bonded nitrogen into molecular nitrogen.

### LIST OF REFERENCE NUMERALS

100 filter module
110 filter layer
120 filter substrate
130 vegetation
140 inner wall
141 base plate
142 ventilation hole
150 horizontal intermediate space
151 horizontal air flow
160 outer wall
170 connecting element
180 vertical ventilation channel
181 vertical air flow
190 transition region between the outer walls
191 seal
200 feeding device
201 first feeding device
202 second feeding device
203 third feeding device
204 fourth feeding device
210 feeding plate
211 opening
212 hollow system
213 T-piece
300 discharge device
400 wastewater feeding line
500 central column, central shaft
510 rising pipe
520 underwater submersible pump
600 intermediate store
700 ground surface
800 wastewater reservoir
810 filtered wastewater
900 flow direction
1000 denitrification stage
1010 denitrification line
P1 first pump
P2 second pump
L1 first line
L2 second line
L3 third line
L4 fourth line
L7 seventh line
V1 first valve
V2 second valve
V3 third valve
RV1 first non-return valve
RV2 second non-return valve

1. Wastewater treatment plant having a plurality of filter layers disposed one under the other for purifying the wastewater, wherein in each case at least one feeding device for feeding wastewater to the filter layer and at least one discharge device for discharging the water purified by the respective filter layer is associated with each filter layer, characterised in that in the case of at least two of the filter layers (110), the feeding device (200) is directly fluidically connected to a wastewater feeding line (400) and the discharge device (300) is directly fluidically connected to an intermediate store (600) such that the unfiltered quantity of wastewater fed to the respective filter layer (110) is purified exclusively by this filter layer (110), wherein the wastewater treatment plant comprises a central shaft for discharging the purified wastewater into an intermediate store (600) by utilising gravitational force.

2. Wastewater treatment plant as claimed in claim 1, characterised in that a filter layer (110), together with the feeding device (200) and discharge device (300) associated with it, forms the essential components of a filter module (100), wherein the feeding device (200) is disposed over the filter layer (110) and this is disposed over the discharge device (300), and wherein wastewater treatment plant comprises a plurality of these modules disposed one under the other.

3. Wastewater treatment plant as claimed in claim 1, characterised in that vegetation (130) is disposed in the uppermost layer (110).

4. Wastewater treatment plant as claimed in claim 2, characterised in that the filter module (100) comprises an outer wall and an inner wall (160, 140), wherein the inner wall (140) serves at least to receive the filter layer (110) and the outer wall (160) serves at least to receive the inner wall (140) and provides a seal with respect to the outside environment.

5. Wastewater treatment plant as claimed in claim 1, characterised in that it comprises a ventilation system which produces substantially vertical air flows, wherein the vertical air flows (181) can be generated on the outer edge of the filter layers (110).

6. Wastewater treatment plant as claimed in claim 1, characterised in that it comprises a ventilation system which produces substantially horizontal air flows (151), wherein the horizontal air flows (151) can be generated on the upper surfaces of the filter layers (110).

7. Wastewater treatment plant as claimed in claim 1, characterised in that the feeding device (200) comprises a plurality of openings (211) which are directed downwardly in the direction of the filter layer (110) in order to discharge the wastewater onto the respective filter layer in a substantially laminar manner.

8. Wastewater treatment plant as claimed in claim 1, characterised in that the feeding device (200) is connected to a feeding line which extends in the central shaft.

9. Wastewater treatment plant as claimed in claim 8,
characterised in that the feeding line, together with a rising pipe and a pump connected to the rising pipe, forms a compact structural unit.

10. Wastewater treatment plant as claimed in claim 8, characterised in that the wastewater treatment plant comprises a ventilation line system for introducing air into each filter level.

11. Wastewater treatment plant as claimed in claim 1, characterised in that the wastewater treatment plant comprises at least one ventilation and/or backwashing device, for ventilating and/or flushing filter layers (110) by means of compressed air and/or water.

12. Method for treating wastewater, in particular for purifying wastewater and utilising the wastewater treatment plant as claimed in claim 1,
wherein wastewater is fed to a plurality of filter layers via their respective feeding device, is filtered by means of the respective filter layer and the filtered wastewater is discharged by means of a discharge device, which is associated with the filter layer, into a central shaft for discharging the purified wastewater into an intermediate store by utilising gravitation force, and is made available,
characterised in that at least some partial quantities of the wastewater are filtered in merely one filter layer (110) in each case, wherein the filter layers (110) filtering the different partial quantities have a respectively different geodetic height.

13. Method for treating wastewater as claimed in claim 12, characterised in that wastewater which is filtered in the wastewater treatment plant is either disposed of or reused or is directed to further purification by being fed once again into the wastewater treatment plant.

14. Method for treating wastewater as claimed in claim 12, characterised in that the wastewater partial quantities are filtered at least in part at the same time.

15. Wastewater treatment system which comprises at least one wastewater treatment plant as claimed in claim 1 and also at least one wastewater reservoir (800), which is fluidically connected to the wastewater treatment plant, for the purpose of receiving the unpurified wastewater.

16. Wastewater treatment system as claimed in claim 15, characterised in that when a plurality of wastewater treatment plants are connected in parallel, their intermediate stores (600) are fluidically connected to each other and in this way provide a complete intermediate store.

17. Method for treating wastewater, in particular for purifying wastewater and utilising the wastewater treatment system as claimed in claim 16, characterised in that in order to recirculate and discharge the purified water, two pumps are provided, and, depending upon the purification objective, the pumps are operated in alternating fashion, so that water collected in the complete intermediate store (600) undergoes recirculation once and is then discharged.
